(19) United States
(12) Patent Application Publication
(10) Pub. No.: US 2007/0118495 A1
(43) Pub. Date: May 24, 2007

(54) Inverse hierarchical approach to data

(75) Inventors: Jasjit Singh Grewal, Sammamish, WA (US); Ilana Rae Smith, Bellevue, WA (US); Andriy Smertin, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/248,348

(22) Filed: Oct. 12, 2005

(51) Int. Cl. G06F 17/30; G06F 7/00

(52) U.S. Cl. 707/1

(57) ABSTRACT

Data may be stored and search starting at the child level of data and progressing toward parent data and grandparent data, if needed.

### BACKGROUND

As users increase the use of computers, the creation of data increases. How to efficient store and search this data has been a challenge. Various models have been created to help make data storage more efficient and understandable. For example, data has been stored in a tree like format where searching for data can entail searching an entire tree when only specific data on a far branch was needed.

### SUMMARY

Data and data definitions may be stored and search starting at the child level of data and progressing toward parent data and grandparent data, if needed. The definitions may first be applied to child data and if the definition is appropriate, it is then applied to parent data and if the definition is not appropriate, it is not applied to the parent data. Similarly, child data is first searched and if a match is found, parent data may also be searched. Further, top-down and bottom-up searches may be combined to obtain the desired results. The data may be customer relationship management data and the data may be stored in XML format.

### DRAWINGS

FIG. 1 is a block diagram of a computing system that may operate in accordance with the claims;

FIG. 2 is an illustration of a flowchart in accordance with a method in accordance with the claims; and

FIG. 3 may be an illustration of a hierarchical tree of data storage.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

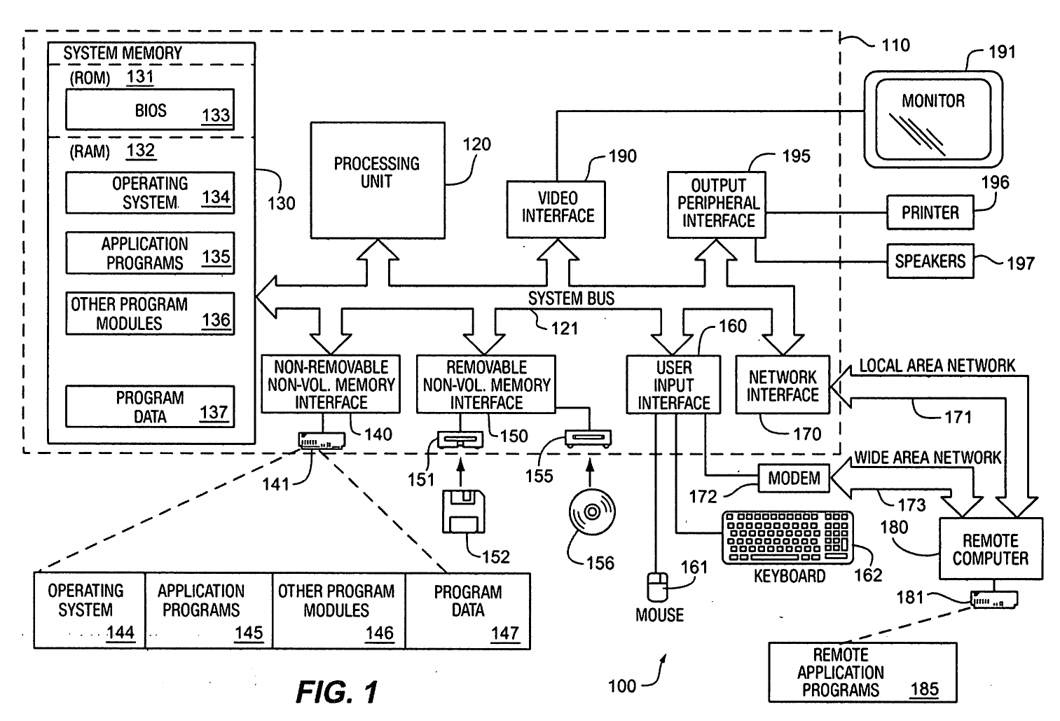

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

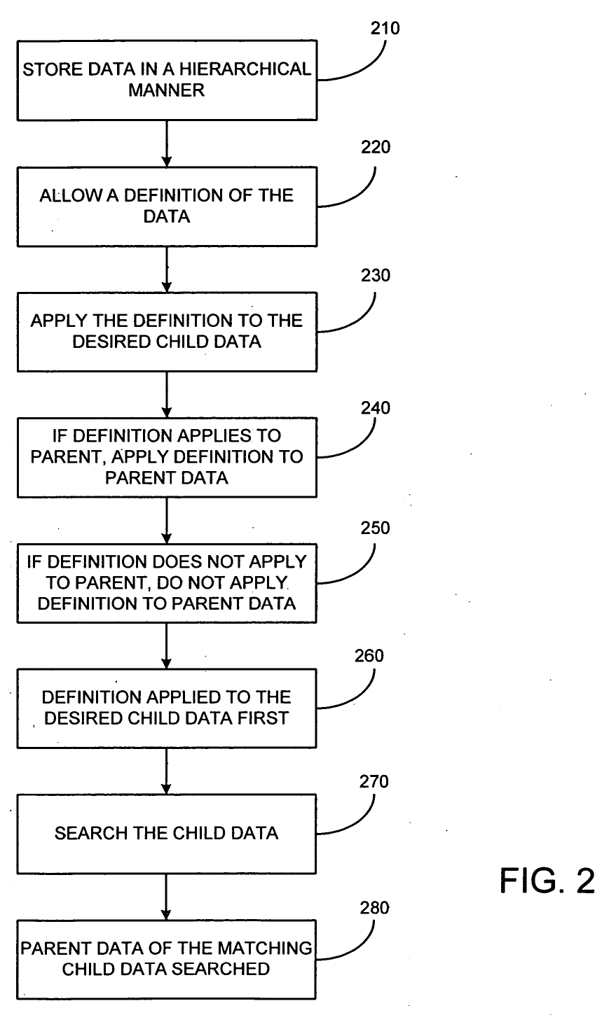

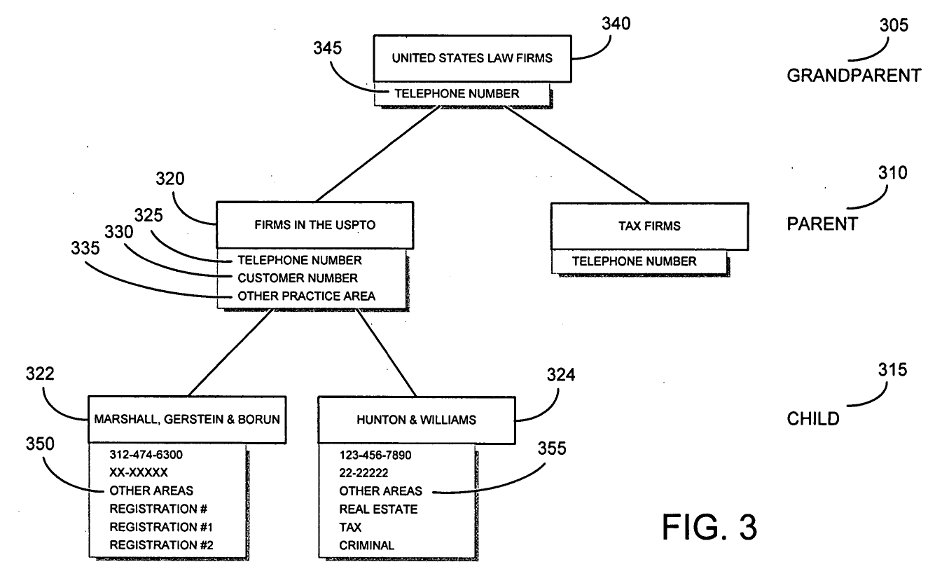

FIG. 2 may be an illustration of a flowchart of a method of defining data in an inverse hierarchical manner in accordance with the claims. At block 210, the method may store data in a hierarchical manner. The common manner to visualize-data stored in a hierarchical manner is to think of a pyramid where a single piece of parent data is at the top and child data resides below. FIG. 3 may be such an example. The child data inherits the characteristics of the parent data and may have additional characteristics and these additional characteristics may not be the same among the children. In addition, the child data may have child data, making the parent data “grandparent data” 305 (FIG. 3) and may mean that all the parent data 310 and children data 315 may have the characteristics of the grandparent data 305. Confusing as it may be, parent data can be classified as child data if the parent data as has its own parent data. In the example in FIG. 3, USPTO firms 320 is parent data to Marshall, Gerstein & Borun LLP 322 and Hunton & Williams 324, but USTPO firms 320 may be child data to US law firms 340.

At block 220, the method may allow a definition of the data. A definition may be another element that is added to each piece of data. For example, if the data being stored is data on firms that practice in front of the USPTO 320 (FIG. 3), a first definition may be the telephone number of the firm 325, a second definition may be the customer number of the firm 330 and a third definition may be other practice areas that the firm has knowledge such as bankruptcy law 335.

At block 230, the method may apply the definition to the desired child data. For example, when looking at firms that practice in front of the USPTO and if a definition is other practice areas that the firm has knowledge, many USPTO patent firms will have no other practice areas 350 (FIG. 3) while some will have other practice areas 355. Accordingly, the definition will not be applied to all the firms. As another example, if the definition is the customer number for the registered patent attorneys, all firms practicing in front of the USPTO should have registered patent attorneys.

At block 240, if the definition applies to the child data 315 (FIG. 3), the definition may be applied to the parent data 310. For example, if the child data is firms that practice in front of the USPTO 320 and the parent data is all firms in the United States 340, the child data (firms that practice in front of the USPTO 320) should have a telephone number 325. In addition, all firms in the United States 340 should have a telephone number 345 so this may be applied from the child data 320 to the parent data (law firms in the United States) 340.

At block 250, if the definition does not apply to the parent data, the definition may not be applied to the parent data. For example, say child data of firms that practice in front of the USPTO is a USPTO customer number 330 (FIG. 3). In the United States, considering the astounding number of law firms, the number of firms that do not practice in front of the USPTO may be quite large. Accordingly, these firms may not have a USPTO customer number 330 and this definition may not be applied from the children (USPTO firms 320) to all the parents (law firms in the United States 340).

At block 260, the definition may be applied to the desired child data first. For example, the example where United States law firms was the parent 340 (FIG. 3) and USPTO firms was the child 320, the definition may be applied to the USPTO firms 320 first. The data definitions may be selected from a plurality of pre-defined data definitions or the method may allow the creation of new data definitions. The data definitions may be applied to some child data of the parent data and not to other child data of the parent data. For example, if the parent was US law firms 340 and the child was USPTO firms 320, if the definition was for USPTO biotech firms, not all USPTO firms 320 are biotech firms. In the example in FIG. 3, Marshall, Gerstein & Borun LLP 322 has a well known biotech practice while Hunton & Williams 324 may not. Accordingly, even though all USPTO firms 320 are children of the parent US law firms 340, not all the children (USPTO firms) 320 may have biotech practices and may not have the biotech definition so this definition may not be applied to all parents.

At block 270, the method may search the data by beginning the search by searching the child data 315 (FIG. 3). Entire books have been written on the different manners to search data. In this case, the search will begin with the child data 315. If there are multiple levels of data, i.e., great-grandparent data, grandparent data, parent data and children data, the method will start with the lowest level of data which may be the child level of data 315.

At block 280, if a search of the child data 315 (FIG. 3) produces a match, then the parent data of the matching child data may be searched. As some parents may have the same definition as the children, the parents will be searched in order to ensure all possible matches are found. In situations where there are multiple levels of data, the search may continue “up” the hierarchy from the bottom (children 315) to the top 305 until a level is found with no matches. For example, if a search of the child data 315 does not produce a match, the search may be stopped and no results may be returned and if a search of the parent data 310 does not produce a match, the search may be stopped and the method may return the matching child data 315.

The method may be effective with customer relationship management (“CRM”) data as CRM file can be complex and full of issues regarding data ownership. By searching the lowest level of data, ownership of data may be established at a precise level. In previous systems, an entire tree may have been labeled with a particular ownership when really, some of the child data was owned by others and required exclusions to be added to the child data owned by others. As an example, a “customer's data” would include the customer record, and all the child records of that customer record (e.g. the orders, credit card purchases, service incidents etc). However, though the segmentation is natural, additional requirements may force further filtering of the resultant data. For example, if archiving dormant customers, then all customers with no activity in the past three months may be archived along with all the child records. However, it may be required to retain credit-card purchases for a one-year period for some accounting purposes, so the archived customer data set would be defined as the customer record and all its sub-objects, except credit card purchases younger than a year old. Extrapolated along additional requirements (e.g. orders must be kept for 30 days, service incidents can never be archived, all these requirements must also be met when archiving a business record etc), it can be seen that defining a hierarchy-based data-set from the top-down can be complicated, repetitive and de-centralized.

A bottom-up approach to defining the hierarchy as described in the claims allows additional criteria to be defined more naturally, in a re-useable and centralized way. It addresses the hierarchy aspect as a clause in the definition of the sub-object, rather than the parent. In the above example, the retained credit card purchases would be defined as those purchases less than a year old OR if a child of an archived business record, then less than 90 days old. The definition of relevant customer records would not mention the credit card purchases.

In addition to the bottom-up methodology, some top-down methodology may also be added to further refine searches. At times, a top-down methodology may be useful to ensure that all results are captured. For example, say C is an “Contact” object and is a child of B and a grandchild of A. A user may have some selection criteria for Contact objects, say “Contacts that live in Seattle”. The inverse hierarchy or bottom-up approach allows user to take the hierarchy A and B (that are “Account” objects, say) into account by having some additional criteria like “Child Of ‘Downloaded’ Accounts”. The selection criteria may end up as “Contacts that live in Seattle or Contacts that are children of downloaded accounts.” As a result, a user may separate the criteria of Accounts from that of Contacts and specify in the Contact criteria any Contacts that are children of Accounts that have met the Account criteria. Another way to conceptualize this idea is to have one set of criteria for a first level of the hierarchy and another set of criteria for a second level of the hierarchy. In the previous example, at the Account level, the Account criteria required that the account be download and at the Contact level, the Contact criteria required that the Contact live in Seattle.

Also, certain links in the hierarchy may implicitly be made to fit criteria just by virtue of being links in the hierarchy. For example, say A is an “Account” object, B is a “Contact” object, and C is a “Sales Order” object. Say that A matches the criteria for Accounts, but B does not match our criteria for Contacts. Say that the criteria for “Sales Order” includes “Child Of ‘Dowloaded’ Accounts”. Based on that criteria, Sales Order C would match. Given that B is a link between A and C, we may say that B is implicitly matched as a result.

The data may be stored in a database. No particular database format, brand or manufacturer is contemplated as the method may operate on virtually any database. The method may be applicable when the data is stored in XML format as the XML format has a built in hierarchy which may lend itself to this method.

The method may also be stored as computer executable instructions that are stored on a computer readable medium such as a tangible computer readable medium as explained previously. In addition, the method may be part of a computer system. The computer system as described in FIG. 1 may have a memory, a processor, an input device and an output device wherein the processor is adapted to execute computer instructions for executing the method.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of defining data in an inverse hierarchical manner comprising:
storing data in a hierarchical manner wherein child data has parent data;
allowing a definition of the data;
applying the definition to the desired child data;
if the definition applies to the parent data, applying the definition to the parent data; and
if he definition does not apply to the parent data, not applying the definition to the parent data.

2. The method of claim 1, further comprising first applying the definition to the desired child data.

3. The method of claim 1, further comprising selecting the data definition from a plurality of pre-defined data definitions.

4. The method of claim 1, further comprising allowing for the creation of new data definitions.

5. The method of claim 1, further comprising allowing the definition to be applied to some child data of the parent data and not applying the definition to other child data of the parent data.

6. The method of claim 1, further comprising searching the data by beginning the search by searching the child data.

7. The method of claim 6, further comprising if a search of the child data produces a match, searching the parent data of the matching child data.

8. The method of claim 6, further comprising if a search of the child data does not produce a match, stopping the search.

9. The method of claim 8, further comprising returning no results as the results of the search.

10. The method of claim 6, further comprising if a search of the parent data does not produce a match, stopping the search.

11. The method of claim 10, further comprising returning the matching child data.

12. The method of claim 1, further comprising storing the data in a database.

13. The method of claim 1, further comprising storing the data in XML format.

14. The method of claim 1, further comprising storing the data in a database in XML format.

15. The method of claim 1, wherein the stored data is customer relationship management data.

16. A tangible computer readable medium comprising computer executable instructions for defining data in an inverse hierarchical manner comprising computer executable instructions for:
storing data in a hierarchical manner wherein child data has parent data;
allowing a definition of the data;
applying the definition to the desired child data;
if the definition applies to the parent data, applying the definition to the parent data;
if the definition does not apply to the parent data, not applying the definition to the parent data;
allowing the definition to be applied to some child data of parent data and not applying the definition to other child data of the parent data.

17. The tangible computer readable medium of claim 16, further comprising computer executable instructions comprising instructions for:
searching the data by beginning the search by searching the child data;
if a search of the child data produces a match, searching the parent data of the matching child data;
if a search of the child data does not produce a match, stopping the search; and
if a search of the parent data does not produce a match, stopping the search.

18. The tangible computer readable medium of claim 16, further comprising computer executable instructions comprising instructions for:
storing customer relationship data as the data;
storing the customer relationship data in a database; and
storing the data in XML format.

19. A computer system comprising a memory, a processor, an input device and an output device wherein the processor is adapted to execute computer instructions for defining data in an inverse hierarchical manner, the computer executable instructions comprising instructions for:
storing data in a hierarchical manner wherein child data has parent data;
allowing a definition of the data;
applying the definition to the desired child data;
if the definition applies to the parent data, applying the definition to the parent data;
if the definition does not apply to the parent data, not applying the definition to the parent data;
allowing the definition to be applied to some child data of first parent data and not applying the definition to other child data of the first parent data;
searching the data by beginning the search by searching the child data;
if a search of the child data produces a match, searching the parent data of the matching child data;
if a search of the child data does not produce a match, stopping the search; and
if a search of the parent data does not produce a match, stopping the search.

20. The computer system of claim 19, further comprising instructions for storing customer relationship data as the data;
storing the customer relationship data in a database; and
storing the data in XML format.
